(19) United States
(12) Patent Application Publication
(10) Pub. No.: US 2024/0391172 A1
(43) Pub. Date: Nov. 28, 2024

(54) ADDITIVE MANUFACTURING APPARATUS AND METHOD FOR PRODUCING A THREE-DIMESIONAL OBJECT

(71) Applicant: EOS GMBH ELECTRO OPTICAL SYSTEMS, Krailling (DE)

(72) Inventors: Vincenzo ABBATIELLO, Gilching (DE); Sebastian MEHL, Olching (DE)

(21) Appl. No.: 18/574,875

(22) PCT Filed: Jun. 23, 2021
(86) PCT No.: PCT/EP2021/067209

§ 371 Date: Dec. 28, 2023

(51) Int. Cl. B29C 64/364; B29C 64/205; B29C 64/25; B33Y 10/00; B33Y 30/00

(52) U.S. Cl. CPC B29C 64/364; B29C 64/205; B29C 64/25; B33Y 10/00; B33Y 30/00

(57) ABSTRACT

An additive manufacturing apparatus for producing a three-dimensional object includes a process chamber for building the object. The process chamber includes the build area and a ceiling of the process chamber located opposite the build area, and a nozzle element is arranged in the ceiling. The nozzle element includes an inlet, an outlet, and gas flow passages in fluidic communication with the inlet and outlet for receiving a gas at the inlet and supplying the gas through the outlet into the process chamber. The outlet faces the build area and has a substantially elongate shape that defines a longitudinal direction of the nozzle element. The plurality of gas flow passages subdivide a cavity of the nozzle element at least along the longitudinal direction.

The present invention relates to an additive manufacturing apparatus for producing a three-dimensional object by means of successively solidifying layers of a building material, a method for producing a three-dimensional object in an additive manufacturing apparatus and a method of generating a gas flow within an additive manufacturing apparatus.

Generally, in an additive manufacturing method a three-dimensional object is produced by successively generating layers that correspond to the respective cross-sections of the object to be produced. In such a method, for example, successive layers of a building material are applied within a build area above a platform that is adjustable in height, and each building material layer is selectively solidified at the positions that correspond to the respective cross-section of the object in that layer. An example of such a method is known by the name “selective laser sintering” or “selective laser melting”, in which one or a plurality of laser beams scan the applied layers of the building material so that at the positions that correspond to the respective cross-section of the object the building material is partly or completely melted and present as a solid body after cooling.

Depending on the kind of the building material used, in particular when using plastic or metal powder as a building material, impurities, such as fumes, smoke, vapors and gases can be generated in the additive manufacturing process and in particular during the process of selective solidification. When using a building material in powder form, impurities can be additionally generated by swirling up powder or powder dust. These impurities can propagate into a process chamber of the additive manufacturing apparatus in which the building process takes place. Impurities can adversely affect the manufacturing process, e.g. by absorbing, scattering or deflecting the laser beam, by depositing on a coupling window used for introducing the laser beam into the process chamber, or by depositing on a building material layer.

In order to meet high quality and efficiency requirements on the manufacturing process, such impurities need to be removed from the process chamber atmosphere. For this purpose, generally a gas stream of a process gas is supplied into the process chamber and discharged therefrom, which gas stream entraps impurities that are present within the process chamber to discharge the impurities and hence reduce the amount of impurities within the process chamber.

US 2018/0065296 A1 describes an apparatus and a method for additively manufacturing a three-dimensional object, the apparatus comprising a process chamber in which the object is produced. During manufacturing of the object a process gas is supplied to the process chamber via an inlet in the form of a nozzle, and is discharged from the process chamber via an outlet, wherein a gas stream flowing through the process chamber is shaped such that a substantially elongate oval impingement area of the gas stream is generated within the build area.

It is an object of the present invention to provide an alternative and/or improved additive manufacturing apparatus and alternative and/or improved methods for producing a three-dimensional object and for generating a gas flow within an additive manufacturing apparatus, which apparatus and methods in particular provide for an improved removal of impurities arising within the process chamber of the additive manufacturing apparatus.

The object is achieved by an additive manufacturing apparatus according to claim 1, a method for producing a three-dimensional object according to claim 14, and a method of generating a gas flow within an additive manufacturing apparatus according to claim 15. Further developments of the invention are given in the dependent claims. The features of the additive manufacturing apparatus, which features are given below or in the dependent claims, can also be used for further development of the methods, and vice versa. Likewise, the features of one of the methods can also be used for further development of the other method. Moreover, features of different embodiments and further developments can be combined among each other.

According to the invention, an additive manufacturing apparatus serves for producing a three-dimensional object by means of successively solidifying layers of a building material within a build area of the additive manufacturing apparatus, the layers corresponding to cross-sections of the object to be produced. The additive manufacturing apparatus comprises a process chamber for building the object, the process chamber comprising the build area and a ceiling of the process chamber located opposite the build area, and a nozzle element for introducing a gas into the process chamber, the nozzle element being arranged in the ceiling of the process chamber. The nozzle element comprises an inlet, an outlet, and a plurality of gas flow passages being in fluidic communication with the inlet and the outlet for receiving a gas at the inlet and supplying the gas through the outlet into the process chamber, wherein the outlet faces the build area, preferably at least a center region of the build area, and wherein the outlet of the nozzle element has a substantially elongate shape, the elongate shape defining a longitudinal direction of the nozzle element, and wherein the plurality of gas flow passages subdivide a cavity of the nozzle element at least along the longitudinal direction.

Herein, the nozzle element being arranged “in the ceiling of the process chamber” is to be understood as also comprising the nozzle element being arranged on the ceiling and/or at the ceiling and/or near the ceiling. Preferably, the nozzle element provides for a passage through the process chamber ceiling for the gas to pass through.

The plurality of gas flow passages being “in fluidic communication” with the inlet and the outlet means in particular that the passages are arranged between the inlet and the outlet. For example, the passages can provide for channels, each channel connecting the inlet and the outlet of the nozzle element to pass gas from the inlet through the channel to the outlet.

As described above, the outlet of the nozzle element faces the build area or at least a center region of the build area. Alternatively or in addition, the gas flow passages and/or the outlet can be designed and/or arranged such that a gas stream exiting the nozzle element is directed substantially towards the build area of the additive manufacturing apparatus.

As described above, the outlet of the nozzle element has a substantially elongate shape, and the elongate shape defines a longitudinal direction of the nozzle element. The longitudinal direction can in particular be a longitudinal extension of the nozzle element. However, this does not necessarily imply that the outlet of the nozzle element has a planar shape; rather, the outlet can be curved or have a shape that is or approximates a segment of a circle, as described below. Such a curved shape can in particular be with respect to the vertical direction of the additive manufacturing apparatus, i.e. in a plane perpendicular to the build area. Generally, as used within the present application, the term “vertical direction” denotes a direction that is perpendicular to the plane of the build area, i.e. perpendicular to the working plane, or the direction in which the building process proceeds.

As described above, the plurality of gas flow passages subdivides a cavity of the nozzle element at least along the longitudinal direction. Alternatively or in addition, the plurality of gas flow passages can be arranged side by side along the longitudinal direction of the nozzle element. Here, the term “side by side” does not necessarily mean that the passages are located directly adjacent to one another, but it also includes cases in which e.g. a thicker wall portion is arranged between two of the passages. A side by side arrangement in the longitudinal direction can in particular refer to an arrangement of the passages in a row extending in the longitudinal direction.

The elongate shape of the outlet can, for example, provide for an elongate shape of a gas stream supplied via the nozzle element into the process chamber, which gas stream enters the process chamber at the ceiling and flows towards its bottom, i.e. in the direction of the build area. As a result, for example, a substantially elongate impingement area of the gas stream within the build area can be achieved. The impingement area can in particular cover substantially an entire extent of the build area parallel to the longitudinal extension of the nozzle element. Furthermore, by subdividing an internal cavity of the nozzle element into a plurality of separate gas flow passages, the gas streaming through the nozzle element is subdivided into separate gas flow portions, each portion being restricted to a passage. Hence, the individual gas flow portions can be prevented from interacting and are restricted to the respective gas flow passage on their course from the inlet to the outlet of the nozzle element. This can result, for example, in a more homogeneous gas stream, i.e. a gas stream with reduced turbulence, being supplied from the outlet of the nozzle element into the process chamber. In particular, the longitudinal subdivision of the internal cavity of the nozzle element can permit, for example, a widening of the gas stream along its passage from the inlet to the outlet of the nozzle element in the longitudinal direction to a larger extent. Generally, widening of the gas stream can cause an increase in turbulence, which, in the case of the nozzle element according to the invention, can be suppressed or at least reduced by the gas stream being subdivided by the individual passages.

Preferably, the nozzle element is produced by an additive manufacturing process and/or in an additive manufacturing apparatus.

It is preferred that the nozzle element is free from any further outlet openings that do not face the build area. Put another way, it is preferred that the nozzle element does not contain any outlet openings that face a side wall of the process chamber and/or the process chamber ceiling. Hence, it is preferred that all outlet openings of the nozzle element from which the gas is supplied into the process chamber face the build area.

The gas used in the additive manufacturing apparatus can be a pure or a substantially pure gas, e.g. argon or nitrogen or a mixture of gases, e.g. a mixture of argon and helium. When using a metal powder based building material for building the three-dimensional object preferably argon is used as a process gas. Preferably the additive manufacturing apparatus is configured to process a metal powder based build material.

According to a particularly preferred embodiment of the invention three-dimensional objects are substantially produced in a keyhole-mode melting process using an additive manufacturing apparatus configured to carry through selective laser melting. A keyhole-mode melting process can be defined, for example, by a specific intensity and scanning speed of an energetic beam, such as a laser beam, that lead to a formation of a vapor capillary. For example, at a scanning speed of 1 m/min, a keyhole-mode melting process can be achieved with an intensity of 2 MW/cm² or more. An upper limit of the intensity can be 8 MW/cm², for example. The occurrence of a keyhole-mode melting process can also depend on the building material used. Generally, a keyhole-mode melting process generates impurities in the process chamber, such as vapors of vaporized building material, or high flow velocities of the exiting gas jets, which cause building material to be whirled up. Such impurities can adversely affect the manufacturing process, i.e. by interaction of the impurities with the beam of energetic radiation, and hence, impurities need to be removed from the process chamber to ensure a good quality of the object to be manufactured. Since an occurrence of impurities generated in the process chamber is higher in the case of a keyhole-mode melting process than other process modes, such as a conduction-mode melting process, the present invention can be particularly advantageous when the manufacturing device is operated in the keyhole-mode melting process to manufacture a three-dimensional object.

Preferably, the nozzle outlet comprises a plurality of outlet openings, each outlet opening being in fluidic communication with a gas flow passage. Further preferably, the nozzle inlet comprises a plurality of inlet openings, each inlet opening being in fluidic communication with at least one of the gas flow passages. More preferably, the number of outlet openings exceeds the number of inlet openings of the nozzle element.

For example, the nozzle element can include internal walls that delimit the outlet openings and/or the inlet openings. The nozzle element can, for example, further include external walls or sidewalls that delimit the outlet openings and/or inlet openings towards the outside of the nozzle element. In particular, the external walls can also delimit the internal cavity of the nozzle element, and the internal and external walls can delimit the plurality of gas flow passages of the nozzle element. The number of outlet openings exceeding the number of inlet openings of the nozzle element can be achieved, for example, in that at least one of the gas flow passages, preferably a majority of the gas flow passages, is/are designed such that they branch out or bifurcate along their course from the inlet to the outlet of the nozzle element. Thus, for example, the degree of subdivision of the internal cavity of the nozzle element into separate passages can increase from the inlet to the outlet, resulting, for example, in an increase of homogeneity of the gas stream from the inlet to the outlet.

Preferably, each gas flow passage comprises an end portion arranged adjacent to the outlet of the nozzle element. In addition, the plurality of gas flow passages preferably comprises at least a central passage and at least a marginal passage, the central passage being arranged at a center of the nozzle element and the marginal passage being arranged next to a margin of the nozzle element with respect to the longitudinal direction, and wherein the end portion of the central passage extends in a first direction that forms an angle of substantially 90° with the build area and the end portion of the marginal passage extends in a second direction that forms an angle with the build area of less than 90°, preferably less than 75°, more preferably less than 60°, most preferably about 45°. Further preferably, the directions of respective end portions of the passages located between the central passage and the marginal passage in the longitudinal direction extend between the first direction and the second direction. This means in particular that the end portions of the passages located between the central passage and the marginal passage in the longitudinal direction extend at respective angles to the build area, which angles lie between the angle of substantially 90° that the first direction forms with the build area, and the angle that the second direction forms with the build area. An angle of substantially 90° means that a deviation from 90° of at most 10°, preferably at most 6°, more preferably at most 4° is comprised.

Alternatively or in addition, it is preferred that a partial gas stream exiting the marginal passage in operation of the nozzle element is substantially directed to an edge of the build area. The direction in which the partial gas stream exits the marginal passage can in particular be substantially the second direction described above. Hence, the angle that the second direction of the end portion of the marginal passage forms with the build area can be selected as a function of a size of the build area, in particular a dimension or maximum dimension of the build area parallel to the longitudinal direction of the nozzle element, and/or a distance, in particular a vertical distance, between the outlet of the nozzle element and the build area, and/or a dimension of the outlet of the nozzle element in the longitudinal direction.

The different directions of the end portions of the gas flow passages along the longitudinal direction can, for example, result in a fan-shaped arrangement of the end portions of the gas flow passages with respect to the longitudinal direction, resulting, for example, in a fan-shaped gas stream being introduced into the process chamber. In particular, the gas stream exiting the outlet of the nozzle element can be flared or widened in the longitudinal direction as compared to a shape of the gas stream entering the nozzle element at the inlet, such that a larger region of the process chamber or of the build area can be covered by the gas stream, for example. This can, in particular, improve removal of impurities from the process chamber.

Alternatively or in addition, the end portion of at least one of the passages, preferably of a plurality of the passages, more preferably of all passages is/are arranged at an angle to an initial portion of the respective passage, and the end portion covers at least half, preferably at least two thirds, more preferably at least three fourths of a total length of the respective passage from the inlet to the outlet of the nozzle element. This embodiment can provide, for example, for the advantage that a location where a change in direction of the gas stream within the passage is effected, i.e. at the transition from the initial portion to the end portion, is located closer to the inlet than to the outlet of the nozzle element. Hence, the gas stream covers a relatively long distance along the end portion of the passage(s) without being further deflected, which can, for example, reduce turbulence of the gas stream and increase its homogeneity.

Alternatively or in addition, it is preferred that each end portion terminates in an outlet opening facing the build area, the outlet openings together forming the outlet of the nozzle element. This results, for example, in a well-defined arrangement of the end portions of gas flow passages and the outlet openings.

Preferably, in a projection of the end portion of the marginal passage along the second direction onto a plane comprising the build area, the mapping of a cross-section of the end portion at least partly, preferably completely lies outside the build area. The direction of the projection, i.e. the second direction of the end portion of the marginal passage, can in particular be an (imaginary) main flow direction of the gas streaming through the marginal passage. Hence, by means of the projected end portion of the marginal passage being located at least partially outside the build area, it can be achieved, for example, that gas streaming through the marginal passages is directed onto a margin or outside the build area to e.g. ensure full coverage of the build area.

Generally, a direction in which a passage or portion of a passage extends can be a mean or median direction of the passage or portion, for example. The direction can generally define an extension of the passage or its portion between the inlet and the outlet of the nozzle element, for example, and/or can be defined by a mean gas flow direction in which the gas passes through the passage or its portion in operation of the nozzle element. In particular, the extension direction of the passage or its portion can be defined as a line connecting the centers of cross-sections, i.e. a course of centers of cross-sections, of the passage/portion along its way from the inlet towards the outlet of the nozzle element. Generally, within the scope of the present disclosure, a course of a cross-section of a passage, or changes thereof, can be obtained, for example, by determining the smallest cross-sectional area of the passage at a plurality of points or at all points that are located along the longitudinal extent of the passage from the inlet to the outlet. The smallest cross-sectional areas can be obtained, for example, by tilting the sectional plane at a pre-determined intersection point, at which intersection point a sectional plane intersects with the wall delimiting the passage, until the smallest sectional plane, which is delimited by the walls of the passage, is obtained. This smallest sectional plane is then the cross-sectional area of the passage at the respective point. For this purpose, mathematical methods for approximation can be applied, for example. In areas where the passage is partially open, e.g. at the inlet and at the outlet, a specific, pre-determined rule can be applied or, for example, the path used for defining the cross-sections can be chosen appropriately, e.g. only areas with a completely enclosed cavity can be taken into consideration, etc.

Alternatively or in addition, a main flow direction of a fluid can be assumed for a respective passage or portion thereof, such as a line located within the passage, and then along this line the smallest cross-sectional area is determined at specific points located on this line, e.g. points having a pre-determined distance, such as 1 mm, to one another. The smallest cross-sectional area can be determined in a sectional plane that intersects both the respective point and the wall(s) delimiting the passage. If this approach does not yield a unique solution for a point, but e.g. two solutions, the solution, i.e. sectional plane, is selected that has the smallest tilt with respect to the sectional plane having been determined for the previous or neighboring point in an iterative approach.

Preferably, in an orthogonal projection of the outlet openings onto a projection plane parallel to the build area, an outline of the projected outlet openings substantially equals an oval, an ellipse or a rectangle, wherein the oval, ellipse or rectangle has an aspect ratio of at least 3:1, more preferably at least 6:1, more preferably at least 10:1, most preferably at least 14:1. Here, the aspect ratio of the outline, i.e. of the oval, ellipse or rectangle, is defined as a ratio of a long side of the outline, which long side is parallel to the longitudinal direction of the nozzle element, to a short side of the outline, the short side preferably extending perpendicular to the long side. Preferably, the aspect ratio of the outline is determined taking its maximum length and width extensions. As used herein, an “oval” does not need to have two symmetry axes or one symmetry axis; rather, it can have an irregular shape without an axial symmetry. Alternatively or in addition, it is preferred that in an orthogonal projection of the outlet of the nozzle element onto a projection plane parallel to the build area, the projected outlet substantially has the shape of an oval, an ellipse or a rectangle, wherein the oval, ellipse or rectangle has an aspect ratio of at least 3:1, more preferably at least 6:1, more preferably at least 10:1, most preferably at least 14:1. Such a projected shape of the outlet or outlet openings can, for example, provide for an elongate shape as described above. By providing an elongate gas outlet or elongate gas outlets that is/are aligned parallel to the longitudinal extension or longitudinal direction of the nozzle element, synergy effect can be achieved through better coordination due to a reduction of a change in direction between the inflow and outflow of the gas, and thus a gas flow can be provided that covers the build area to a greater extent and contaminations can be removed from a larger region, for example.

Preferably, a dimension of the outlet of the nozzle element in the longitudinal direction is smaller than or substantially corresponds to a dimension of the build area measured in a direction parallel to the longitudinal direction of the nozzle element. As described above, it is preferred that a projection of the gas streams exiting the marginal passage(s) of the nozzle element in an angled direction (e.g. the first direction mentioned above) to the build area covers the build area extension in one direction, in particular in the longitudinal direction. Therein, the length of the nozzle element itself can be substantially smaller than the build area dimension in the longitudinal direction, and coverage of the build area by the gas stream can be ensured by the diverging passage(s) or partial gas stream(s).

Preferably, the additive manufacturing apparatus comprises a recoater moving across the build area in a movement direction for applying layers of the building material within the build area, the movement direction of the recoater being substantially parallel to the longitudinal direction of the nozzle element. In particular in the case of one or several outlet ports being provided for discharging the gas from the process chamber, and the outlet port(s) being located outside the build area such that the gas stream reaching the build area is laterally deflected in a direction traverse, preferably perpendicular, to the longitudinal direction to flow towards the outlet port(s), the movable arrangement of the recoater as described above (i.e. substantially parallel to the longitudinal direction) can provide, for example, for an advantage of a more space-efficient arrangement of outlet port(s) and the recoater within the process chamber, and/or avoiding collision of the recoater with the outlet port(s), and/or preventing or reducing an effect the recoater travel may have on the gas stream being supplied into the process chamber via the nozzle element.

Preferably, the nozzle element further comprises a central partition element extending continuously from the inlet to the outlet of the nozzle element and dividing each of the plurality of gas flow passages to form a plurality of first gas flow passages located on a first side of the central partition element and a plurality of second gas flow passages located on a second side of the central partition element opposite the first side. The first gas flow passages and second gas flow passages can in particular be located on opposite sides of the central partition element along a width direction of the nozzle element, the width direction being perpendicular to the longitudinal direction of the nozzle element and preferably parallel to the build area.

Preferably, the nozzle element further comprises sidewalls, i.e. external walls, and the gas flow passages are delimited at least in a horizontal direction, in particular in the width direction, by the central partition element and a sidewall each. Alternatively, the central partition element preferably protrudes from the sidewalls of the nozzle element and/or its outlet in a direction towards the build area. This in particular means that the central partition element preferably further extends towards the build area than the sidewalls of the nozzle element. Alternatively or in addition, the nozzle element preferably comprises internal walls that delimit the gas flow passages at least in the longitudinal direction, and which internal walls extend between the central partition element and the sidewalls.

Generally, it is preferred that at least in the second half, preferably in at least the last two thirds, further preferably in at least the last three fourths, of a passage from the inlet to the outlet of the nozzle element the internal walls are continuous. The second half or the last two thirds/three fourths here refer to the respective portion of the passage adjacent to the outlet of the nozzle element. Thus, it can be achieved, for example, that the gas flow passages delimited by internal walls are continuous at least in their last portions adjacent the outlet of the nozzle element to, for example, improve the homogeneity of the gas flow exiting the nozzle element.

Preferably, the central partition element has a first section that tapers in a direction towards the inlet of the nozzle element, the first section further preferably being located at a distance from the inlet. In particular, the central partition element can comprise a third section located upstream of the first section and preferably extending from the inlet of the nozzle element to the first section. The third section preferably has a small dimension in a direction (e.g. width direction) perpendicular to the length direction of the nozzle element and can be formed, for example, as a flat or planar plate or thin walled structure. Alternatively or in addition, the central partition element preferably has a second section that tapers in a direction toward the outlet of the nozzle element. Further preferably, the second section is located downstream of the first section and/or the second section is located adjacent to the outlet of the nozzle element. Alternatively or in addition, the tapering shape of the second section is preferably sharper than the tapering shape of the first section. In particular, it is preferred that the first section and the second section together form a teardrop shape. The teardrop shape can also be referred to as a spike shape. Hence, the central partition element or at least its first and second sections can also be referred to as a central spike of the nozzle element. The shape of the central partition element as described above, i.e. the first, second and third sections, can in particular refer to a view of the nozzle element in a cross-sectional plane, which plane passes centrally through the nozzle element from the inlet to the outlet, in particular parallel to the vertical direction, and perpendicular to the longitudinal direction of the nozzle element.

Here, the terms “upstream” and “downstream” refer to a gas stream passing from the inlet through the gas flow passages to the outlet of the nozzle element during operation.

According to a further embodiment, the central partition element preferably is arranged to be movable within the nozzle element in a direction towards the build area and/or away from the build area, i.e. in the vertical direction.

Preferably, the central partition element divides the plurality of gas flow passages along a width direction of the nozzle element substantially perpendicular to the longitudinal direction.

By means of the central partition element as described above, a further subdivision of the internal cavity of the nozzle element can be achieved, for example. In particular, the central partition element can effect an additional division of the gas flow passages with respect to the width direction of the nozzle element. This additional division can, for example, provide for additional homogenization of the gas stream flowing through the nozzle element during operation, e.g. by reducing turbulence of the gas stream.

Furthermore, the central partition element can, for example, contribute to an overall internal shape of the gas flow passages, in particular in a region adjacent to the outlet of the nozzle element. By means of the first and second sections a reduction in width of the gas flow passages can be achieved, for example. Furthermore, the teardrop shape of the first and second sections can provide for an aerodynamic profile, for example, that e.g. further improves the flow properties of the gas streaming through the nozzle element.

Preferably, the gas flow passages are shaped and/or arranged within the nozzle element such that a substantially homogeneous velocity distribution of partial gas streams exiting the gas flow passages at the outlet of the nozzle element is achieved. Thus, for example, a gas stream of improved homogeneity with respect to its flow properties can be achieved within the process chamber, which in turn can improve removal of impurities from the process chamber, for example.

Preferably, in a cross-sectional view of the nozzle element in a plane passing centrally through the nozzle element from the inlet to the outlet, preferably parallel to the vertical direction, and perpendicular to the longitudinal direction of the nozzle element, the outlet of the nozzle element has a substantially V-shaped contour. This can, for example, be achieved by the central partition element projecting further towards the build area than the sidewalls of the nozzle element, as described above. Hence, for example, the central partition element may provide for additional guidance of the gas stream being supplied into the process chamber, thus providing for further improvement of the flow properties of the gas stream, such as reduced turbulence.

Preferably, the plurality of gas flow passages are shaped and arranged such that they fan out from the inlet towards the outlet of the nozzle element, preferably such that the outlet forms a segment of a circle or a spline curve or a polygonal curve (i. e. a polygonal chain or polyline), which spline curve or a polygonal curve preferably approximates a segment of a circle. Thus, for example, a widening of the gas stream from the inlet towards the outlet of the nozzle element can be achieved, resulting in a larger region of the process chamber and/or of the build area being covered by the gas stream, for example.

Preferably, a total opening cross-sectional area of the gas inlet of the nozzle element exceeds a total opening cross-sectional area of the gas outlet of the nozzle element. For example, the total cross-sectional area of the gas outlet of the nozzle element can amount to 70% at most, preferably 50% at most, more preferably about 30% of the total opening cross-sectional area of the gas inlet of the nozzle element. Alternatively or in addition, at least one of the gas flow passages, preferably a majority of gas flow passages, more preferably all gas flow passages, has/have a cross-sectional area that decreases, preferably monotonously decreases, from the inlet towards the outlet of the nozzle element. Alternatively, the decrease in cross-sectional area of the gas flow passage(s) can also be step-wise. A decrease in cross-sectional area along the path of the gas stream from the inlet to the outlet of the nozzle element can result in an increase of velocity of the gas stream passing through the nozzle element, for example.

Alternatively or in addition, at least one of the gas flow passages can comprise a diffusor section, i.e. a section in which the cross-sectional area increases for the inlet to the outlet. Such a diffusor section can, for example, further reduce turbulence of the gas flow.

Preferably, the nozzle element has a substantially circular cross-section at the inlet, wherein further preferably the additive manufacturing apparatus comprises a gas supply line to supply gas to the nozzle element, the inlet of the nozzle element being reversibly connectable to the gas supply line. For example, an end section of the gas supply line can comprise an interface for reversibly connecting the nozzle element to the gas supply line. Preferably, the end section extends in a direction substantially perpendicular to the build area, i.e. in the vertical direction. In particular, the end section of the supply line that connects to the nozzle element can have a circular cross-section that corresponds to the circular cross-section of the inlet of the nozzle element. A circular end section can provide for a space-efficient design of the supply line, for example. In particular, the nozzle element being provided with a circular inlet can effect a change in the shape of the gas stream passing there through, i.e. from a circular cross-section to the elongate shape imposed upon the gas stream by the shape of the outlet and internal structuring of the nozzle element. In particular, the overall shape of the nozzle element and/or its internal cross-sectional shape preferably decreases in the width direction and increases in the length direction from the inlet to the outlet.

Preferably, the nozzle element has a shape that is substantially symmetric with respect to a symmetry plane passing centrally through the nozzle element from the inlet to the outlet, preferably perpendicular to the build area, and parallel to the longitudinal direction of the nozzle element and/or perpendicular to the longitudinal direction of the nozzle element. This can, for example, provide for a more homogeneous shape and distribution of flow properties of a gas stream being supplied via the nozzle element into the process chamber.

Preferably, the nozzle element protrudes from the process chamber ceiling into the process chamber within an upper height region of the process chamber that corresponds to an uppermost 20%, preferably an uppermost 10% of a process chamber height measured from the build area to the ceiling. This can, for example, reduce a disturbing effect that the nozzle element, being provided as a structural element within the process chamber, may have upon one or several gas stream being generated in the process chamber and/or one or several energetic beams used for the selective solidification of the building material.

Preferably, the process chamber ceiling comprises a plurality of coupling windows for introducing at least one energetic beam used for selectively solidifying layers of the building material within the build area, and wherein the inlet of the nozzle element is located between at least two coupling windows, preferably centrally between at least two coupling windows. Thus, the nozzle element can, for example, be used in a so-called multi scanner apparatus that comprises two or more solidification units (e.g. laser-/scanner-units) for generating energetic beams that selectively solidify the building material.

Preferably, the additive manufacturing apparatus comprises at least one further gas inlet, preferably a plurality of gas inlet openings distributed over at least a portion of the process chamber ceiling. Thus, for example, removal of impurities for the process chamber can further be improve.

Preferably, the process chamber comprises at least a first gas outlet port for discharging gas from the process chamber, the first gas outlet port being arranged within a lower height region of the process chamber that adjoins the build area, wherein the first gas outlet port has an elongate shape with a longitudinal direction being substantially parallel to the longitudinal direction of the nozzle element. Further preferably, the process chamber comprises a second gas outlet port for discharging gas from the process chamber, the second gas outlet port being arranged in the lower height region of the process chamber and having an elongate shape with a longitudinal direction being substantially parallel to the longitudinal direction of the nozzle element, and wherein the first and second gas outlet ports are arranged at opposite sides of the process chamber with the build area located between them. For example, the elongate outlet port(s) can be particularly well suited to discharge the elongate gas stream supplied by the nozzle element into the process chamber, in particular by allowing for the elongate gas stream to be removed from the process chamber along its entire length extension. Hence, the homogeneity of the gas stream flowing across the build area towards the outlet port(s) can be further increased, e.g. its turbulence decreased, and the lateral gas stream flowing off towards the outlet port(s) can cover a large region of the build area, for example.

According to the invention, a nozzle element is provided that is configured to be used in an additive manufacturing apparatus. The additive manufacturing apparatus can in particular be an additive manufacturing apparatus described above. The nozzle element comprises an inlet, an outlet, and a plurality of gas flow passages being in fluidic communication with the inlet and the outlet for receiving a gas at the inlet and supplying the gas through the outlet into a process chamber of the additive manufacturing apparatus. The nozzle element further comprises attachment means for connecting, preferably reversibly connecting, the nozzle element to a ceiling of the process chamber, the attachment means preferably being provided at or near the inlet of the nozzle element. The outlet of the nozzle element has a substantially elongate shape, the elongate shape defining a longitudinal direction of the nozzle element, and the plurality of gas flow passages subdivide a cavity of the nozzle element at least along the longitudinal direction. The nozzle element can be further developed by the features described above with respect to the nozzle element of the additive manufacturing apparatus of the present invention. In particular, the nozzle element can be a nozzle element described above with respect to the additive manufacturing apparatus of the present invention. For example, the nozzle element can be provided separately from the additive manufacturing apparatus, such as in the form of an equipping or retrofitting kit, and can be removably mounted within the process chamber of the additive manufacturing apparatus.

The invention further provides for the use of a nozzle element in an additive manufacturing apparatus for producing a three-dimensional object by means of successively solidifying layers of a building material within a build area of the additive manufacturing apparatus, the layers corresponding to cross-sections of the object to be produced, wherein the additive manufacturing apparatus comprises a process chamber for building the object, the process chamber comprising the build area and a ceiling of the process chamber located opposite the build area. The nozzle element is arranged in the ceiling of the process chamber and introduces a gas into the process chamber. The nozzle element comprises an inlet, an outlet, and a plurality of gas flow passages being in fluidic communication with the inlet and the outlet for receiving a gas at the inlet and supplying the gas through the outlet into the process chamber, wherein the outlet faces the build area, preferably at least a center region of the build area. The outlet of the nozzle element has a substantially elongate shape, the elongate shape defining a longitudinal direction of the nozzle element, and wherein the plurality of gas flow passages subdivide a cavity of the nozzle element at least along the longitudinal direction.

According to the invention, a method for producing a three-dimensional object in an additive manufacturing apparatus is provided, the method comprising successively solidifying layers of a building material within a build area of the additive manufacturing apparatus, the layers corresponding to cross-sections of the object to be produced.

The additive manufacturing apparatus comprises a process chamber for building the object, the process chamber comprising the build area and a ceiling of the process chamber located opposite the build area, and a nozzle element for introducing a gas into the process chamber, the nozzle element being arranged in the ceiling of the process chamber. The nozzle element comprises an inlet, an outlet, and a plurality of gas flow passages being in fluidic communication with the inlet and the outlet for receiving a gas at the inlet and supplying the gas through the outlet into the process chamber, wherein the outlet faces the build area, preferably at least a center region of the build area, wherein the outlet of the nozzle element has a substantially elongate shape, the elongate shape defining a longitudinal direction of the nozzle element, and wherein the plurality of gas flow passages subdivide a cavity of the nozzle element at least along the longitudinal direction. The production method further comprises introducing a gas through the nozzle element into the process chamber at least temporarily during the manufacturing of the three-dimensional object. Thus, for example, the same advantages can be achieved as described above with respect to the additive manufacturing apparatus.

According to the invention, a method of generating a gas flow within an additive manufacturing apparatus for producing a three-dimensional object by means of successively solidifying layers of a building material within a build area of the additive manufacturing apparatus, the layers corresponding to cross-sections of the object to be produced, is provided. The additive manufacturing apparatus comprises a process chamber for building the object, the process chamber comprising the build area and a ceiling of the process chamber located opposite the build area, a gas supply device for generating a gas stream within the process chamber, and a nozzle element for introducing a gas into the process chamber. The nozzle element is arranged in the ceiling of the process chamber and comprises an inlet, an outlet, and a plurality of gas flow passages being in fluidic communication with the inlet and the outlet for receiving a gas at the inlet and supplying the gas through the outlet into the process chamber, wherein the outlet faces the build area, preferably at least a center region of the build area, wherein the outlet of the nozzle element has a substantially elongate shape, the elongate shape defining a longitudinal direction of the nozzle element, and wherein the plurality of gas flow passages subdivide a cavity of the nozzle element at least along the longitudinal direction. The method comprises introducing gas through the nozzle element into the process chamber at least temporarily during and/or before and/or after the manufacturing of the three-dimensional object. Thus, for example, the same advantages can be achieved as described above with respect to the additive manufacturing apparatus.

Preferably, the gas stream is formed of partial gas streams, each partial gas stream being supplied from one of the gas flow passages of the nozzle element into the process chamber, wherein preferably a variation of the velocities of the partial gas streams measured and/or acquired at the outlet of the nozzle element is less than 30%, more preferably less than 20%, more preferably less than 10%, particularly preferably less than 5%. The velocities of the partial gas streams measured and/or acquired at the outlet of the nozzle element can in particular refer to the locations where the partial gas streams leave the gas flow passages towards or into the process chamber. Thus, the homogeneity of the gas stream being supplied into the process chamber can be enhanced, in particular with respect to its velocity distribution.

Preferably, in a lower height region of the process chamber the gas stream substantially forms a first flow region and a second flow region with a third flow region located between the first and second flow regions, wherein the third flow region has a substantially elongate shape extending in a direction parallel to the longitudinal direction of the nozzle element in a plane parallel to the build area, and in the third flow region a gas flow rate of the gas stream towards the build area and/or a velocity of the gas stream is reduced as compared to respective gas flow rates and/or velocities in the first and second regions.

Further features and expediencies of the present invention are described below based on exemplary embodiments and with reference to the attached drawings.

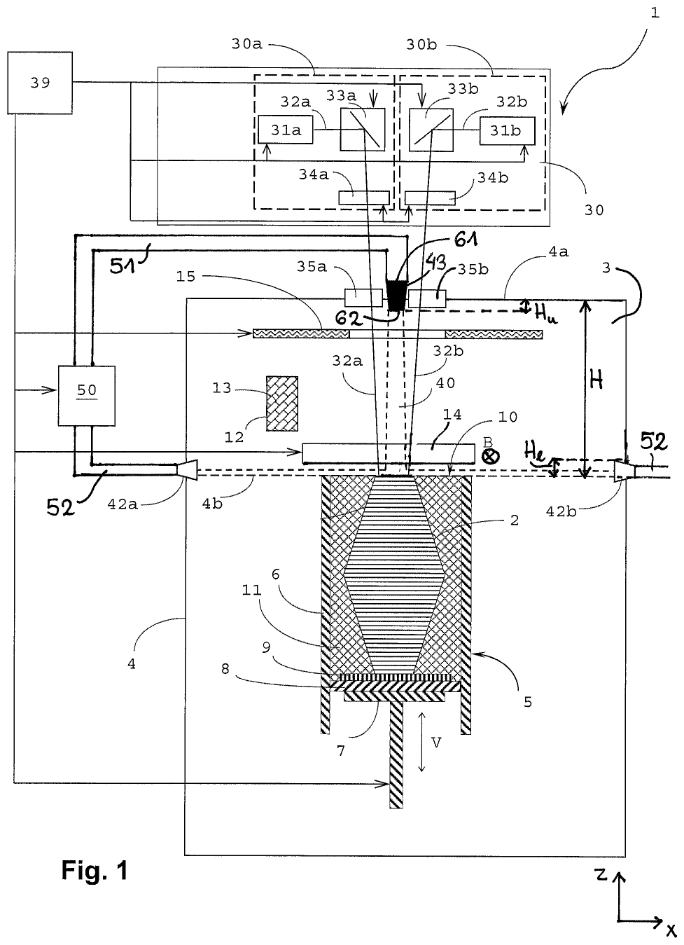

FIG. 1 is a schematic view, partially in cross-section, of an additive manufacturing apparatus according to an embodiment of the present invention.

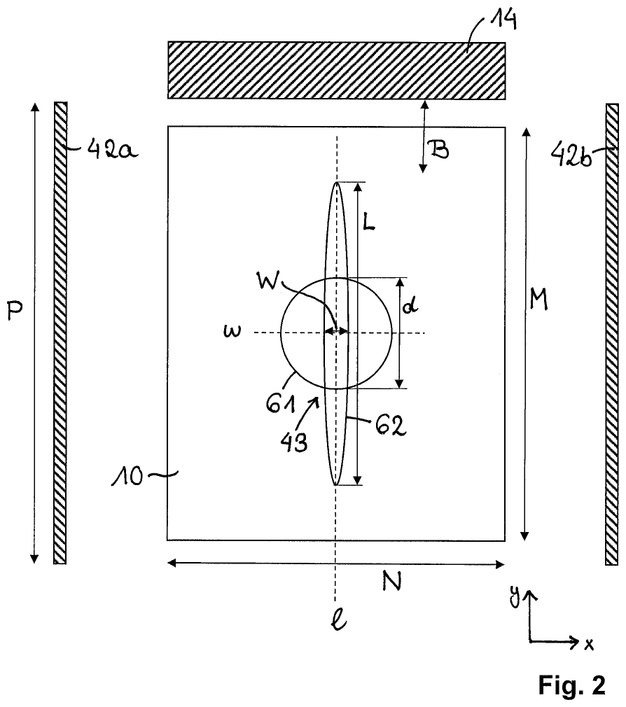

FIG. 2 is a schematic view of an inlet and of an outlet of the nozzle element shown in FIG. 1, the inlet and outlet being projected onto a plane of the build area of the apparatus shown in FIG. 1.

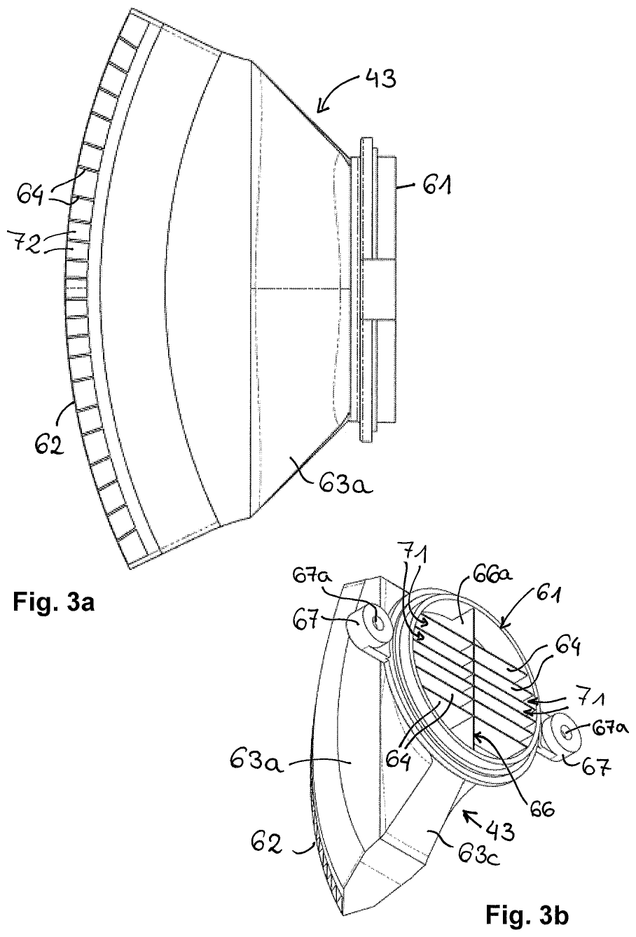

FIGS. 3a and 3b are schematic, perspective views of the nozzle element shown in FIG. 1.

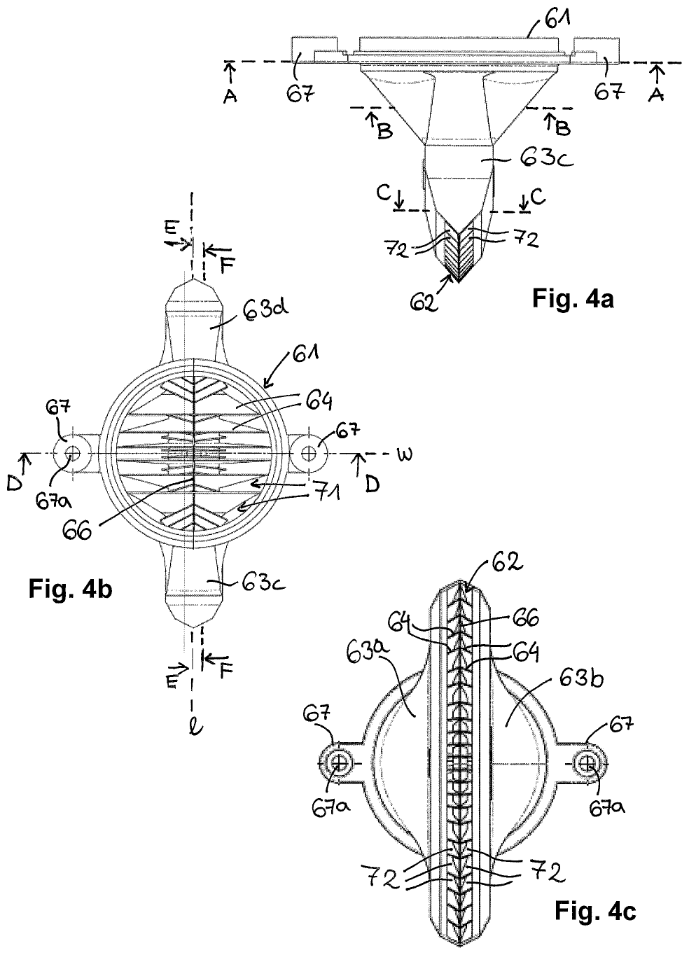

FIGS. 4a, 4b and 4c are schematic, perspective views of the nozzle element of FIG. 1, wherein FIG. 4a is a view of the nozzle element from its side, FIG. 4b shows the nozzle element in view onto its inlet and FIG. 4c shows the nozzle element in view onto its outlet.

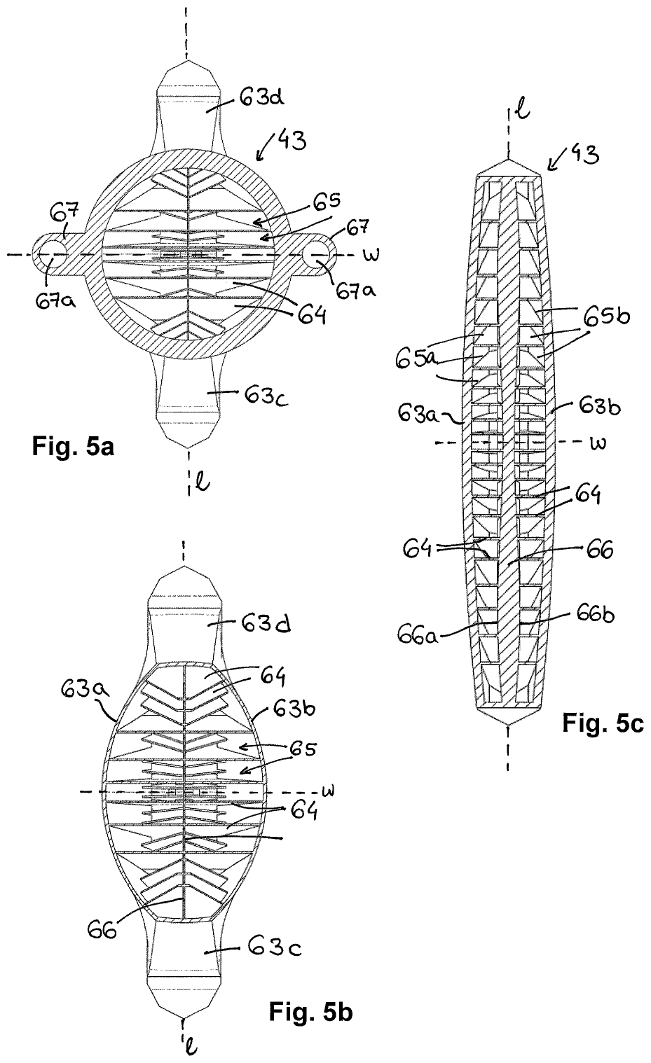

FIGS. 5a, 5b and 5c are schematic views of the nozzle element of FIG. 1 in cross-section taken along the line A-A (FIG. 5a), along the line B-B (FIG. 5b) and along the line C-C (FIG. 5c) in FIG. 4a.

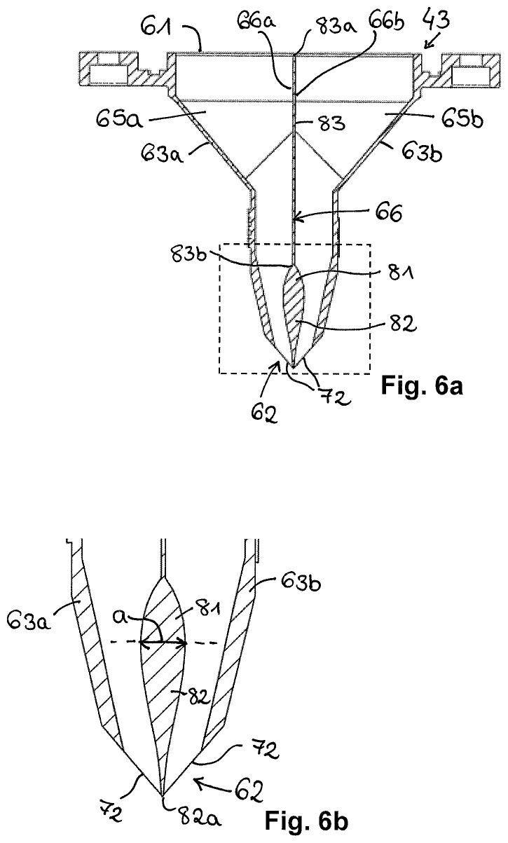

FIG. 6a is a schematic view of the nozzle element of FIG. 1 in cross-section taken along the line D-D in FIG. 4b, and FIG. 6b shows an enlarged view of the portion of the nozzle element framed by a dashed line in FIG. 6a.

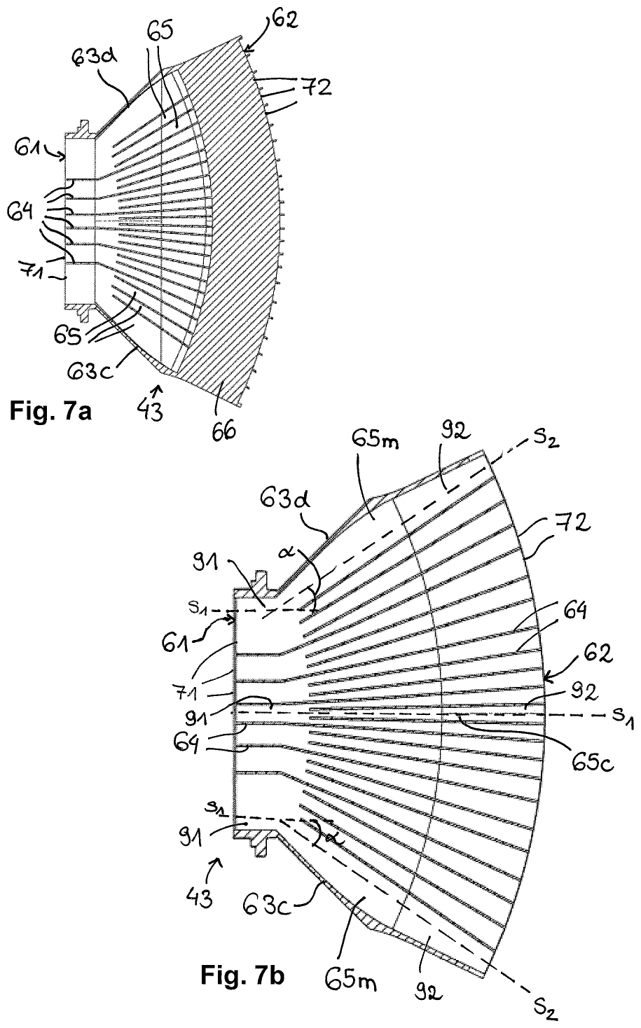

FIGS. 7a and 7b are schematic views of the nozzle element of FIG. 1 in cross-section taken along the line E-E (FIG. 7a) and along the line F-F (FIG. 7b) in FIG. 4b.

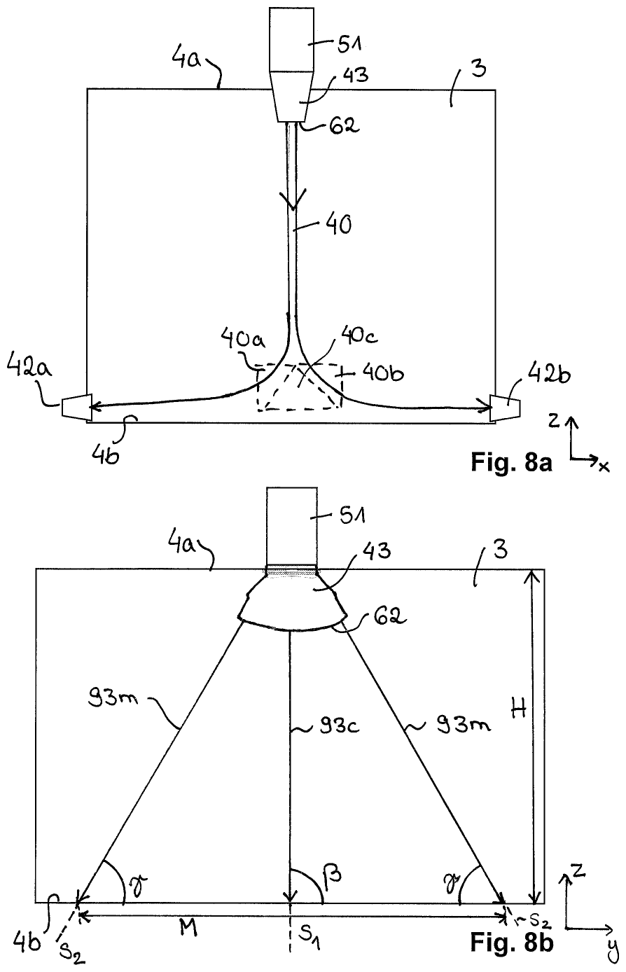

FIGS. 8a and 8b are schematic views of the upper portion of the process chamber of FIG. 1 in cross-section during operation of the nozzle element, wherein FIG. 8a shows the process chamber in a cross-section perpendicular to the longitudinal direction of the nozzle element and FIG. 8b shows the process chamber in a cross-section parallel to the longitudinal direction of the nozzle element.

Hereinafter, an additive manufacturing apparatus according to an embodiment of the present invention will be described with respect to FIG. 1. The additive manufacturing apparatus schematically depicted in FIG. 1 is a laser sintering of laser melting apparatus 1 and serves for producing a three-dimensional object 2 from a building material.

The apparatus 1 comprises a process chamber 3 having a chamber wall 4 with a process chamber ceiling 4a. A building container 5 is arranged within the process chamber 3, the container 5 having a container wall 6. An upper edge of the container wall 6 defines a working plane (not shown in the figures), and the area of the working plane located within the container 5 is denoted as a build area 10. In the embodiment of FIG. 1, a process chamber bottom 4b is located around the container 5 and in a plane defined by the build area, i.e. in the working plane. A distance between the process chamber ceiling 4a and the process chamber bottom 4b defines a height H of the process chamber 3.

A support 7 is arranged within the container 5, the support 7 being movable in a vertical direction V. A base plate 8 is attached to the support 7, which base plate 8 closes the container 5 to the bottom and thus forms the bottom of the container 5. The base plate 8 can be a plate formed separately from the support 7 and attached to the support 7, or it can be formed integrally with the support 7. Depending on a building material and a process used for the production of the object 2, a separate platform 9 can be attached to the base plate 8, which platform 9 serves as a building support on which the object 2 is built. Alternatively, the object 2 can be built on the base plate 8 itself, which then serves as a building support. In FIG. 1, the object 2 to be built on the platform 9 within the container 5 is shown below the build area 10 in an intermediate state with several layers being already solidified and surrounded by building material 11 that remained unsolidified.

The apparatus 1 further comprises a storage container 12 for a building material 13, such as a building material in powder form, which building material can be solidified by electromagnetic radiation. Furthermore, the apparatus 1 comprises a recoater 14 that is arranged to be movable in a horizontal direction, denotes as a recoating direction B, for applying a layer of the building material 13 within the build area 10 on the building support or a previously applied layer. In the view of FIG. 1, the recoating direction B is perpendicular to the drawing plane, as indicated by a cross within a circle in FIG. 1. Optionally, a radiant heater 15 is arranged in the process chamber 3 for heating an applied layer of the building material 13.

The apparatus 1 further comprises a solidification device for selectively solidifying the layers of the building material 13 applied within the build area. In the example of FIG. 1, the solidification device 30, which is also referred to as an irradiation device, comprises a first solidification unit 30a and a second solidification unit 30b. Each solidification unit 30a, 30b comprises a respective laser 31a, 31a generating a respective laser beam 32a, 32b. The laser beams 32a, 32b are deflected by respective deflecting devices 33a, 33b of the solidification units 30a, 30b and are then focused by focusing devices 34a, 34b through coupling windows 35a, 35b that are arranged in the process chamber ceiling 4a, to impinge onto the build area 10.

The solidification device 30 used with the apparatus 1 can also deviate from the embodiment depicted in FIG. 1. For example, the solidification device can comprise only one solidification unit or more than two solidification units. Furthermore, instead of providing a plurality of, e.g. two, lasers, only one laser can be provided and the plurality of, e.g. two, laser beams can be generated by means of a beam splitter.

Furthermore, a gas supply device is provided for supplying a gas stream 40 of a process gas via a nozzle element 43 into the process chamber 3 and for discharging the process gas via outlet ports 42a, 42b from the process chamber. In FIG. 1, the gas supply device comprises a gas conveying device 50, such as a turbine or a pump, connected to a gas supply line 51 that feeds gas to the nozzle element 43 and to a gas discharge line 52 that receives gas from the outlet ports 42a, 42b. In FIG. 1, an end portion of the gas supply line 51 that connects to an inlet 61 of the nozzle element 43 extends substantially perpendicular to the build area 10.

In the present embodiment, the nozzle element 43 is arranged at or in the process chamber ceiling 4a and protrudes into the process chamber 3 within an upper height region Hᵤ of the process chamber. For example, the upper height region Hᵤ corresponds to the uppermost 10% of the process chamber height H. Alternatively, an outlet 62 of the nozzle element 43, which outlet 62 faces the build area 10, can be arranged to be flush with the process chamber ceiling 4a, i.e. the nozzle element 43 can be arranged so that it does not protrude into the process chamber 3. In the present embodiment, the nozzle element 43 is arranged approximately centrally between the coupling windows 35a and 35b assigned to the solidification units 30a and 30b shown in FIG. 1. The nozzle element 43 and the gas stream 40 generated during operation of the gas supply device will be described in more detail below with reference to FIGS. 2 to 8b.

The outlet ports 42a, 42b are arranged in or at opposite sides of the process chamber wall 4 such that the build area 10 is located between them. Each outlet port can comprise one or several outlet openings (not shown in FIG. 1) connecting to the discharge line 52 to discharge gas from the process chamber 3. The outlet ports 42a, 42b are arranged within a lower height region Hₗ of the process chamber that adjoins the build area. For example, the lower height region Hₗ corresponds to the lowermost 10% of the process chamber height H.

The apparatus 1 further comprises a control unit 39 by means of which the individual components of the apparatus can be controlled in a coordinated manner, as indicated by arrows in FIG. 1, for implementing a building process. Alternatively or in addition, the control unit can be arranged partially or completely outside the apparatus 1. As used herein, the term “control unit” means any computerized controller capable of controlling the operation of an additive manufacturing machine or any component thereof. As is known in the art, the control unit can include a computer processing unit, memory, and output such as a wireless transceiver or a wireless port. In many instances, the control unit can be a computer. For example, the control unit can contain a central processing unit (CPU) whose operation is controlled by a computer program (software). The computer program can be stored separately from the apparatus on a storage medium, from which it can be loaded into the apparatus, in particular into the control unit 39.

In operation of the apparatus 1, the support 7 is first lowered by an amount that corresponds to a desired layer thickness. Then, the recoater 14 first moves to the storage container 12 and receives therefrom an amount of building material sufficient for applying at least one layer. Then, the recoater 14 moves across the build area 10 and there applies a layer of the building material 13 onto the platform 9 or onto a layer already present. Optionally, the applied layer of the building material 13 is heated by means of the radiant heater 15. Subsequently, the cross-section of the object 2 to be produced is scanned by at least one, preferably both, of the laser beams 32a and 32b such that the building material 13 is solidified at the locations that correspond to the cross-section of the object 2. These steps are repeated until the object 2 is completed and can be removed from the process chamber 3.

At least temporarily during and/or before and/or after the manufacturing of the three-dimensional object 2, the gas stream 40 of a process gas is supplied via the nozzle element 43 into the process chamber 3 and discharged from the process chamber 3 via the outlet ports 42a, 42b in order to remove impurities from the process chamber, in particular impurities generated during selective solidification of the building material.

Next, the nozzle element 43 will be described in more detail with reference to FIGS. 2 to 8b.

Generally, the nozzle element 43 comprises an inlet 61, an outlet 62, and external walls in the form of sidewalls 63a, 63b, 63c, 63d extending between the inlet 61 and the outlet 62 to delimit an internal cavity of the nozzle element that is in fluidic communication with the inlet 61 and the outlet 62. A plurality of internal walls 64 are provided that subdivide the cavity into a plurality of gas flow passages 65, each gas flow passage 65 extending between the inlet 61 and the outlet 62 and hence being in fluidic communication with the inlet and the outlet for receiving gas at the inlet 61 and supplying the gas through the outlet 62 into the process chamber 3. As can be seen best in FIGS. 1, 8a and 8b, the inlet 61 of the nozzle element 43 connects to the gas supply line 51, and the outlet 62 of the nozzle element faces the build area 10.

The nozzle element 43 of the present embodiment further comprises a central partition element 66 extending continuously from the inlet 61 to the outlet 62 of the nozzle element 43 and dividing each of the plurality of gas flow passages 65 to form a plurality of first gas flow passages 65a located on a first side 66a of the central partition element 65 and a plurality of second gas flow passages 65b located on a second side 66b of the central partition element 66 opposite the first side.

As can be seen best in FIG. 2, the outlet 62 of the nozzle element 43 has a substantially elongate shape, the elongate shape defining a longitudinal direction I of the nozzle element 43. In the present example, the longitudinal direction extends parallel to the plane of the build area 10, i.e. parallel to the working plane. A width direction w of the nozzle element 43 is defined as the direction that is perpendicular to the length direction I and parallel to the plane of the build area 10. Hence, the width direction w, the length direction I and the vertical direction (i.e. perpendicular to the plane of the build area 10) define a Cartesian coordinate system with the width direction w of the nozzle element 43 extending in the x-direction, the length direction I of the nozzle element 43 extending in the y-direction and the vertical direction extending in the z-direction of the Cartesian coordinate system. In the view of FIG. 2, the z-direction is not visible.

In the projection view of FIG. 2, the outlet 62 of the nozzle element 43 has a substantially elongate oval shape with a length L as its maximum dimension extending along the length direction I, and a width W along the width direction w, and the inlet 61 has a substantially circular shape with a diameter d. Central points of the cross-sectional areas of the inlet 61 and the outlet 62 (not shown in FIG. 2) coincide in the view of FIG. 2 in the present embodiment of the nozzle element 43. The diameter d of the inlet 61 preferably equals a diameter of a circular cross-section of the end portion of the gas supply line 51 connecting to the inlet of the nozzle element 43 (not shown in FIG. 2). The length L of the outlet 62 of the nozzle element 43 exceeds the diameter d of the inlet 61, and the diameter d of the inlet exceeds the width W of the outlet 62. Hence, the cavity of the nozzle element 43 (not shown in the figures) has an overall shape that decreases in the width direction w from the inlet towards the outlet 62, and that increases in the length direction I from the inlet towards the outlet 62. As can be best seen in FIGS. 3a, 3b, preferably an overall shape of the nozzle element 43 at its outside, i.e. defined by its sidewalls 63a, 63b, 63c, 63d, likewise decreases in the width direction w and increases in the length direction I from the inlet 61 to the outlet 62 of the nozzle element. Moreover, in the present embodiment, the cross-sectional area of the inlet 61 exceeds the cross-sectional area of the outlet 62 of the nozzle element. For example, the cross-sectional area of the outlet 62 can amount to 30% of the opening cross-sectional area of the inlet 61. As will be explained in more detail below, the inlet 61 and the outlet 62 can be formed by a plurality of inlet openings and outlet openings each. The cross-sectional areas of the inlet 61 and of the outlet 62 can then be a sum of the respective cross-sectional areas of the inlet openings or outlet openings.

Turning back to FIG. 2, in the present embodiment, the build area 10 has a substantially rectangular shape with a length M of the rectangle extending parallel to the longitudinal direction I of the nozzle element 43 and a width N of the rectangle extending parallel to the width direction w of the nozzle element 43. In the present embodiment, the length M of the build area 10 exceeds the length L of the outlet 62 of the nozzle element 43. In FIG. 2, the recoater 14 is arranged outside the build area 10 and movable in the recoating direction B back and forth along the length M of the build area 10, i.e. parallel to the longitudinal direction I of the nozzle element 43. In the present embodiment, the recoater 14 extends perpendicular to its movement direction along a length that substantially corresponds to the width N of the build area 10. However, the length of the recoater 14 perpendicular to the recoating direction B can also exceed or be smaller than the width N of the build area 10.

The outlet ports 42a and 42b are arranged outside the build area 10 and spaced apart from one another along the width direction w of the nozzle element. The outlet ports 42a, 42b in FIG. 2 each have an elongate shape (here: a rectangular shape) with a longitudinal direction of the outlet ports 42a, 42b being substantially parallel to the longitudinal direction I of the nozzle element. A length P of the outlet ports 42a, 42b in the longitudinal direction I is at least as large as the length M of the rectangular build area 10 and preferably exceeds the length M of the build area 10, as shown in FIG. 2.

As can best be seen in FIGS. 3a to 5c, the nozzle element 43 comprises attachment means for reversibly connecting the nozzle element 43 to the process chamber ceiling 4a. In the present embodiment, the attachment means are in the form of two lateral extensions 67 provided at or near the inlet 61 of the nozzle element 43, which lateral extensions 67 protrude from the nozzle element in the width direction w, for example. Each extension 67 comprises one or several through-holes 67a for receiving a fixation means, such as a screw, (not shown) therein to attach the nozzle element to the process chamber ceiling 4a.

Furthermore, the nozzle element 43 of the present embodiment is designed to be substantially symmetric with respect to a vertical plane passing centrally through the nozzle element 43 along its longitudinal direction I, and is substantially symmetric also with respect to a vertical plane passing centrally through the nozzle element 43 along its width direction w. The symmetric shape refers both to the external shape of the nozzle element 43, determined in particular by its lateral sidewalls 63a, 63b and its front and back sidewalls 63c, 63d, as well as to the internal structure of the nozzle element, determined by the internal walls 64 and the central partition element 66 that delimit the gas flow passages 65.

Generally, the internal walls 64 of the nozzle element 43 are substantially planar walls extending in the width direction w and in a direction from the inlet 61 towards the outlet 62. The internal walls 64 are preferably thin walls, i.e. a width of the internal walls 64 along the longitudinal direction I of the nozzle element is relatively small. Along the width direction w of the nozzle element, the internal walls 64 preferably extend continuously from each lateral sidewall 63a and 63b of the nozzle element to the central partition element 66. The internal sidewalls are spaced apart from one another along the longitudinal direction I of the nozzle element to delimit the gas flow passages 65 in the longitudinal direction. Hence, the gas flow passages 65 are arranged along the longitudinal direction I of the nozzle element.

Furthermore, the central partition element 66 extends continuously from the inlet 61 to the outlet 62 of the nozzle element and continuously between the front sidewall 63c and the back sidewalls 63d, i.e. along the entire dimension of the internal cavity of the nozzle element in the longitudinal direction I. The central partition element divides the gas flow passages 65 along the width direction w of the nozzle element so as to form a row of first gas flow passages 65a delimited by a first one of the lateral sidewalls 63a and the first side 66a of the central partition element 66, and a row of second gas flow passages 65b delimited by the other lateral sidewall 63b of the nozzle element 43 and the second side 66b of the central partition element 66. Preferably, the central partition element 66 is arranged to be centrally between the lateral sidewalls 63a and 63b.

Furthermore, the internal walls 64 and the partition element 66 subdivide the inlet 61 of the nozzle element into a plurality of inlet openings 71 that supply gas to the individual gas flow passages 65. Likewise, the internal walls 64 and the partition element 66 subdivide the outlet 62 of the nozzle element into a plurality of outlet openings 72 that supply gas from the individual gas flow passages 65 into the process chamber 3. Preferably, the number of outlet openings 72 exceeds the number of inlet openings 71 (cf. also FIGS. 7a, 7b). For example, the number of inlet openings 71 can be 14 and the number of outlet openings 72 can be 46, as shown in the present embodiment.

Turning now in particular to FIGS. 6a and 6b, the central partition element 66 will be described in more detail. As seen in the cross-sectional view of FIGS. 6a and 6b, which cross-section is taken along the width direction w of the nozzle element, the central partition element 66 comprises a first section 81 that tapers in a direction towards the inlet 61 of the nozzle element, a second section 82 that tapers in a direction toward the outlet 62 of the nozzle element, and a third section 83 that substantially has a constant dimension along the width direction w of the nozzle element.

The third section 83 can have a substantially flat or planar shape, e.g. can be formed as a thin wall. The third section 83 substantially extends between the inlet and the outlet of the nozzle element from a first end 83a of the third section, the first end 83a being provided substantially at the inlet 61 of the nozzle element, to a second end 83b where it merges into the first section 81 of the central partition element 66. Hence, the first section 81 of the central partition element 66 is located at a distance from the inlet 61.

As seen in the sectional view of FIGS. 6a, 6b, the first section 81 widens from the second end 83b of the third section 83 towards the second section 82, i.e. the width of the first section 81 increases in the width direction w, preferably continuously increases, towards the outlet 62 of the nozzle element. At a maximum width a of the first section 81, the first section 81 merges into the second section 82 that tapers, i.e. is reduced in width, towards the outlet 62 of the nozzle element. The second section 82 ends at a tip 82a that faces away from the first section 81. As can be seen best in FIG. 6b, the tapering shape of the second section 82 is sharper than the tapering shape of the first section 81, and the first section 81 and the second section 82 together form a substantially teardrop shape, also referred to as a spike shape.

In the width direction w of the nozzle element, the central partition element 66 is arranged at a distance to both lateral sidewalls 63a, 63b to form the respective gas flow passages 65a, 65b between the respective lateral sidewall 63a or 63b of the nozzle element 43 and the respective side 66a or 66b of the central partition element 66. Moreover, the central partition element 66, i.e. its second section 82, and the lateral sidewalls 63a, 63b delimit the outlet openings 72 of the nozzle element 43 in the width direction w. Furthermore, the central partition element 66, i.e. the tip 82a of its second section 82, extends further in a direction away from the inlet 61, i.e. towards the build area 10 when the nozzle element 43 is mounted in the process chamber 3 (cf. FIG. 1), than respective ends of the lateral sidewalls 63a, 63b. This means that in the mounted position of the nozzle element 43, the central partition element 66 protrudes from the sidewalls 63a, 63b in a direction towards the build area 10. Therefore, in the sectional view of FIGS. 6a, 6b, the outlet 62 of the nozzle element 43 has a substantially V-shaped contour.

As shown in the sectional view of FIG. 6a, the shape of the lateral sidewalls 63a, 63b and of the central partition element 66 is such that a dimension of the gas flow passages 65a, 65b in the width direction w decreases from the inlet 61 or respective inlet opening 71 towards the outlet 62 or respective outlet opening 72.

As can best be seen in the cross-sectional views of FIGS. 7a and 7b, which cross-sections are taken along the longitudinal direction I of the nozzle element, the gas flow passages 65 are shaped and arranged within the nozzle element 43 such that they fan out from the inlet 61 towards the outlet 62 of the nozzle element. In particular, the outlet 62 of the nozzle element 43 does not have a planar shape in the longitudinal direction I, but rather, the outlet 62 forms a segment of a circle, for example (cf. also FIG. 3a, 3b). In the view of FIG. 7a, the gas flow passages 65 are partially hidden from view by the first and second sections 81, 82 of the central partition element 66 (cf. FIG. 6a, 6b). The cross-sectional view of FIG. 7b is selected such that the passages 65 are visibly along their entire extent from the inlet 61 to the outlet 62.

In detail, as can be seen best in FIG. 7a, each gas flow passage 65 comprises an initial portion 91 arranged adjacent to the inlet 61 of the nozzle element 43, and an end portion 92 arranged adjacent to the outlet 62 of the nozzle element 43. Each end portion 92 of the passages 65 terminates in an outlet opening 72. In FIG. 7a, the initial portions 91 and end portions 92 are only depicted for a central passage 65c and the two marginal passages 65m. The central passage 65c is located at the center of the nozzle element 43 with respect to the longitudinal direction I, and the marginal passage 65m are located next to the front and back sidewalls 63c, 63d with respect to the longitudinal direction I, i.e. next to the margins of the nozzle element 43 with respect to the longitudinal direction I.

In the cross-sectional view of FIG. 7b, the central passages 65c extends substantially straight from the inlet 61 to the outlet 62, such that the initial portion 91 and the end portion 92 of the central passage 65c are parallel to one another and extend in a first direction $1. Preferably, the first direction s₁ is substantially perpendicular to the build area 10, i.e. forms an angle β of about 90° with the plane of the build area 10, when the nozzle element 43 is mounted in the process chamber 3 (cf. FIG. 8b). Furthermore, in the cross-sectional view of FIG. 7b, the initial portion 91 of the marginal passages 65m extends substantially in the first direction s₁ and the end portion 92 of the marginal passages 65m extends in a second direction s₂ that forms an angle α with the first direction s₁. For example, the angle α formed between the first direction s₁ and the second direction s₂ can be about 45°. Hence, the second direction s₂ forms an angle γ with the plane of the build area 10 when the nozzle element 43 is mounted in the process chamber 3 (cf. FIG. 8b). In the present example, the angle γ is about 45°.

The end portions 92 of the passages located between the central passage 65c and one of the marginal passages 65m in FIG. 7b extend in directions between the first direction s₁ and the second direction s₂ so as to form a transition between the central passage 65c and the marginal passage 65m to achieve the fan-shaped arrangement of the gas flow passages 65. Preferably, the transition between the first portion 91 and the second portion 92 of the passages 65, i.e. the location between the inlet 61 and the outlet 62 where the passages 65 (except for the central passage 65c) are provided with a bend in the cross-sectional view of FIG. 7b, is preferably closer to the inlet 61 than to the outlet 62 of the nozzle element. For example, the end portion 92 of the passages 65 covers at least three fourths of a total length of the respective passage 65 from the inlet 61 to the outlet 62.

Furthermore, the fan-shaped arrangement of the gas flow passages 65 in the present embodiment, in combination with the number of outlet openings 72 exceeding the number of inlet openings 71, is achieved in that the number of internal walls 64 increases from the inlet 61 towards the outlet 62 of the nozzle element 43, as depicted in FIG. 7b. For example, the number of internal walls 64 provided on one of the sides of the central partition element 66 can be 6 at the inlet 61 and can be 22 at the outlet 62. An increase in the number of internal walls 64 can result in the gas flow passages 65 branching out or bifurcating along their course from the inlet 61 to the outlet 62 of the nozzle element 43, as depicted in the cross-sectional view of FIG. 7b.

In the above, the shape and arrangement of the gas flow passages 65 with respect to the width direction w of the nozzle element 43 was discussed in particular with reference to FIGS. 6a, 6b, and the shape and arrangement of the gas flow passages 65 with respect to the longitudinal direction I of the nozzle element 43 was discussed in particular with reference to FIGS. 7a, 7b. Hence, in synopsis of FIGS. 6a-7b and the preceding figures, the three-dimensional shape of the gas flow passages is preferably such that the cross-sectional area of each individual passage 65 decreases in the width direction w and increases in the longitudinal direction I from the inlet 61 to the outlet 62. However, preferably the amount of decrease in the width direction w exceeds the amount of increase in the longitudinal direction I, such that the cross-sectional area of each individual passage 65 decreases from the inlet 61 to the outlet 62 of the nozzle element 43. Thus, a velocity of a partial gas stream flowing through the respective passage 65 from the inlet 61 to the outlet 62 of the nozzle element generally increases. Preferably, the gas flow passages 65 are shaped and arranged within the nozzle element 43 such that a substantially homogeneous velocity distribution of partial gas streams exiting the gas flow passages 65 at the outlet openings 72 is achieved.

Schematic views of the gas stream generated in the process chamber by the gas flowing through the nozzle element 43 into the process chamber 3 in operation of the gas supply device will now be described with reference to FIGS. 8a, 8b and further reference to the preceding figures. Generally, during operation, the gas stream 40 exiting the outlet 62 of the nozzle element 43 during operation is formed by partial gas streams, each partial gas stream being supplied into the process chamber from one outlet opening 72. For the sake of simplicity, only the central partial gas stream 93c exiting the central passage 65c in FIG. 7b and the marginal partial gas streams 93m exiting the marginal passages 65m in FIG. 7b are depicted in FIG. 8b, and no further marginal gas streams that exit the gas flow passages 65 located between the central passage 65c and the marginal passages 65m during operation are depicted in FIG. 8b. Furthermore, for the sake of simplicity, in FIG. 8a no partial gas streams are depicted.

As shown in the cross-sectional view of the process chamber 3 of FIG. 8a, which cross-sectional view is taken along the width direction w of the nozzle element 43, the gas stream 40 exiting the outlet 62 of the nozzle element 43 during operation is directed substantially downwards and streams in a non-guided manner towards the build area 10. In the width direction w, the partial gas streams exiting the individual outlet openings 72 (not shown in FIG. 8a) form a collimated gas stream 40, i.e. in the width direction w (x-direction), the gas stream 40 exiting the outlet 62 of the nozzle element has a relatively small width. Due to the elongate shape of the gas stream 40 in the longitudinal direction I (y-direction, cf. FIG. 8b), as well as a possible suctioning effect of the gas outlet ports 42a, 42b being arranged at the lateral sides of the build area 10 with respect to the width direction w of the nozzle element 43, the gas stream 40 is laterally deflected in the width direction w (x-direction) towards the outlet ports 42a, 42b in a lower region of the process chamber adjacent the build area, as depicted in FIG. 8a. The deflection is caused in particular by means of a layer applied in the build area 10 or an upper surface of the building support being located in the build area 10, which prevents the gas stream 40 from flowing further downwards. For example, deflection of the gas stream 40 towards the outlet ports 42a, 42b can take place within a lower height region of the process chamber corresponding to the lowermost quarter, preferably a lowermost sixth, particularly preferably a lowermost eighth of the process chamber height H.

Additionally taking into account the longitudinal extension of the gas stream 40 (cf. below and FIG. 7b), in the lower height region of the process chamber 3 the gas stream 40 thus substantially forms three flow regions schematically depicted in FIG. 8a: A first flow region 40a and a second flow region 40b with a third flow region 40c located between the first flow region 40a and the second flow region 40b in the x-direction (i.e. the width direction w). Perpendicular to the drawing plane in FIG. 8a, the three flow regions 40a, 40b, 40c have a substantially elongate shape extending in the longitudinal direction I of the nozzle element 43. Due to the lateral deflection of the gas stream 40 a gas flow rate and a velocity of the gas in the third flow region 40c is reduced as compared to the gas flow rates and velocities of the gas in the first and second flow regions 40a, 40b.

FIG. 8b schematically depicts the central partial gas stream 93c exiting the central passage 65c (cf. FIG. 7b) and the marginal partial gas streams 93m exiting the marginal passages 65m (cf. FIG. 7b), wherein, due to the respective orientations of the end portions 92 of the central and marginal passages 65c, 65m, the central partial gas stream 93c exits the outlet 62 of the nozzle element 43 substantially in the first direction s₁ (cf. FIG. 7b) and hence is directed substantially perpendicular, i.e. at the angle β of about 90°, to the plane of the build area 10. Likewise, the marginal partial gas streams 93m exit the outlet 62 of the nozzle element 43 substantially in the second direction s₂ (cf. FIG. 7b) and hence are substantially directed towards the plane of the build area 10 at the angle γ of about 45°. For the sake of simplicity, the deflection of the partial gas streams in the lateral direction (width direction w) within the lower height region of the process chamber, which is explained above with reference to FIG. 8a, is not depicted in FIG. 8b. Also widening effects of the partial gas streams flowing from the nozzle element towards the build area are not depicted in FIG. 8b.

As schematically depicted in FIG. 8b, the second direction s₂ of the end portion 92 of the marginal passages 65m (cf. FIG. 7b) and the height H of the process chamber are selected such that the marginal partial gas streams 93m are substantially directed towards the edges of the build area with respect to the longitudinal direction I (y-direction). This means that the second direction s₂, i.e. the angle γ, is selected such that the gas stream 40 substantially covers the entire extent of the build area 10 in the longitudinal direction I, i.e. the length M of the build area 10 of the present embodiment (cf. FIG. 2). Generally, the angle formed between the second direction s₂ and the build area 10 is furthermore selected dependent on a vertical distance between the nozzle outlet 62 and the build area 10 and a dimension of the build area 10 along the longitudinal direction I (y-direction). Hence, due to the fan-shaped arrangement of the gas flow passages 65 of the nozzle element 43, the gas stream 40 is spread in the longitudinal direction I to cover a larger region of the build area, preferably, the entire build area.

Modifications and further developments of the additive manufacturing apparatus and nozzle element described above with reference to FIGS. 1 to 8b are possible without deviating from the scope of the present invention.

For example, in a modification of the nozzle element, the central partition element is arranged to be movable within the nozzle element in the vertical direction, i.e. towards the build area and/or away from the build area. Furthermore, the nozzle element can be provided without the central partition element.

Further gas inlet(s) for introducing a gas into the process chamber can be provided in addition to the nozzle element 43. For example, the additive manufacturing apparatus can comprise a plurality of gas inlet openings distributed, preferably evenly, over at least a portion of the process chamber ceiling, which inlet openings supply a gas into the process chamber that flows substantially downwards towards the build area.

Furthermore, the build area 10 is not limited to a rectangular shape, as described above in particular with reference to FIG. 2. Rather, the build area can have any other geometric shape.

Although the present invention is described herein with reference to a laser sintering or laser melting apparatus, it is not limited to laser sintering or laser melting. The present invention can be applied to any apparatus and method for the additive manufacturing of a three-dimensional object by means of successively solidifying layers of a building material within a build area of the additive manufacturing apparatus.

A solidification device for the selective solidification by means of supplying energy can, for instance, comprise one or more gas or solid state lasers or any other type of lasers, such as e.g. laser diodes, in particular VCSEL (Vertical Cavity Surface Emitting Laser) or VECSEL (Vertical External Cavity Surface Emitting Laser) or one or several columns of these lasers. Generally, any device for selectively introducing energy into a layer of the building material in the form of radiation can be used for the selective solidification. For example, instead of a laser, any another light source, an electron beam, or any energy or radiation source can be used that is suitable for solidifying the building material. Instead of deflection of a beam, a moving solidification device can be moved, such as a movable line irradiation device. The invention can also be applied to selective mask sintering, where an extended light source and a mask are used, or to the High-Speed-Sintering (HSS), where a material is selectively applied onto the building material which material enhances (absorption sintering) or reduces (inhibition sintering) the absorption of radiation at the corresponding points and then an irradiation is performed non-selectively in a large-area manner or using a movable line irradiation device.

Alternatively, the selective solidification of the applied building material can also be implemented by 3D-printing, e.g. by applying an adhesive, for example. Instead of selectively introducing energy, a building material can also be selectively applied layer by layer.

In the context of the present invention, basically all types of building material that are suitable for additive manufacturing can be used, in particular plastics (e.g. polymers), metals, ceramics, respectively preferably in powder form, sand, filled or mixed powders.

1. An additive manufacturing apparatus for producing a three-dimensional object by successively solidifying layers of a building material within a build area of the additive manufacturing apparatus, the layers corresponding to cross-sections of the object to be produced, wherein the additive manufacturing apparatus comprises:
a process chamber for building the object, the process chamber comprising the build area and a ceiling of the process chamber located opposite the build area; and
a nozzle element for introducing a gas into the process chamber, the nozzle element being arranged in the ceiling of the process chamber,
wherein the nozzle element comprises an inlet, an outlet, and a plurality of gas flow passages in fluidic communication with the inlet and the outlet for receiving a gas at the inlet and supplying the gas through the outlet into the process chamber, wherein the outlet faces the build area,
wherein the outlet of the nozzle element has a substantially elongate shape, the elongate shape defining a longitudinal direction of the nozzle element, and wherein the plurality of gas flow passages subdivide a cavity of the nozzle element at least along the longitudinal direction.

2. The additive manufacturing apparatus of claim 1, wherein the nozzle outlet comprises a plurality of outlet openings, each outlet opening being in fluidic communication with a gas flow passage.

3. The additive manufacturing apparatus of claim 2, wherein the nozzle inlet comprises a plurality of inlet openings, each inlet opening being in fluidic communication with at least one of the gas flow passages, and wherein preferably the number of outlet openings exceeds the number of inlet openings of the nozzle element.

4. The additive manufacturing apparatus of claim 1, wherein each gas flow passage comprises an end portion arranged adjacent to the outlet of the nozzle element, and
wherein the plurality of gas flow passages comprises at least a central passage and at least a marginal passage, the central passage being arranged at a center of the nozzle element and the marginal passage being arranged next to a margin of the nozzle element with respect to the longitudinal direction, and wherein the end portion of the central passage extends in a first direction that forms an angle of substantially 90° with the build area and the end portion of the marginal passage extends in a second direction that forms an angle with the build area of less than 90°; and/or
wherein the end portion of at least one of the passages is/are arranged at an angle to an initial portion of the respective passage, and wherein the end portion covers at least half of a total length of the respective passage from the inlet to the outlet of the nozzle element; and/or
wherein each end portion terminates in an outlet opening facing the build area, the outlet openings together forming the outlet of the nozzle element.

5. The additive manufacturing apparatus of claim 4, wherein in a projection of the end portion of the marginal passage along the second direction onto a plane comprising the build area, the mapping of a cross-section of the end portion at least partly.

6. The additive manufacturing apparatus of claim 2, wherein in an orthogonal projection of the outlet openings onto a projection plane parallel to the build area, an outline of the projected outlet openings is shaped as an oval, an ellipse or a rectangle, wherein the oval, ellipse or rectangle has an aspect ratio of at least 3:1.

7. The additive manufacturing apparatus of claim 1, wherein a dimension of the outlet of the nozzle element in the longitudinal direction is smaller than or substantially corresponds to a dimension of the build area-measured in a direction parallel to the longitudinal direction of the nozzle element, and/or
wherein the additive manufacturing apparatus comprises a recoater moving across the build area in a movement direction for applying layers of the building material within the build area, the movement direction of the recoater-being substantially parallel to the longitudinal direction of the nozzle element.

8. The additive manufacturing apparatus of claim 1, wherein the nozzle element comprises a central partition element extending continuously from the inlet to the outlet of the nozzle element and dividing each of the plurality of gas flow passages to form a plurality of first gas flow passages located on a first side of the central partition element and a plurality of second gas flow passages located on a second side of the central partition element opposite the first side.

9. The additive manufacturing apparatus of claim 8, wherein the central partition element has a first section that tapers in a direction towards the inlet of the nozzle element, the first section,
and/or wherein the central partition element has a second section that tapers in a direction toward the outlet of the nozzle element, the second section,
and/or wherein the tapering shape of the second section is sharper than the tapering shape of the first section wherein the first section and the second section together form a teardrop shape.

10. The additive manufacturing apparatus of claim 8, wherein the central partition element divides the plurality of gas flow passages along a width direction of the nozzle element substantially perpendicular to the longitudinal direction.

11. The additive manufacturing apparatus of claim 1, wherein the gas flow passages are shaped and/or arranged within the nozzle element such that a substantially homogeneous velocity distribution of partial gas streams exiting the gas flow passages at the outlet of the nozzle element is achieved and/or
wherein, in a cross-sectional view of the nozzle element in a plane passing centrally through the nozzle element from the inlet to the outlet and perpendicular to the longitudinal direction of the nozzle element, the outlet of the nozzle element has a substantially V-shaped contour and/or
wherein the plurality of gas flow passages are shaped and arranged such that they fan out from the inlet towards the outlet of the nozzle element, such that the outlet forms a segment of a circle or a spline curve or a polygonal curve, which spline curve or polygonal curve approximates a segment of a circle.

12. The additive manufacturing apparatus of claim 1, wherein a total opening cross-sectional area of the gas inlet of the nozzle element exceeds a total opening cross-sectional area of the gas outlet of the nozzle element, and/or
wherein at least one of the gas flow passages has/have a cross-sectional area that decreases from the inlet towards the outlet of the nozzle element.

13. The additive manufacturing apparatus of claim 1, wherein the nozzle element has a substantially circular cross-section at the inlet, wherein the additive manufacturing apparatus comprises a gas supply line to supply gas to the nozzle element, the inlet of the nozzle element being reversibly connectable to the gas supply line.

14. The additive manufacturing apparatus of claim 1, wherein the nozzle element has a shape that is substantially symmetric with respect to a symmetry plane passing centrally through the nozzle element from the inlet to the outlet and parallel to the longitudinal direction of the nozzle element and/or perpendicular to the longitudinal direction of the nozzle element.

15. The additive manufacturing apparatus of claim 1, wherein the process chamber comprises at least a first gas outlet port for discharging gas from the process chamber, the first gas outlet port being arranged within a lower height region of the process chamber that adjoins the build area, wherein the first gas outlet port has an elongate shape with a longitudinal direction being substantially parallel to the longitudinal direction of the nozzle element, and
wherein the process chamber preferably comprises a second gas outlet port for discharging gas from the process chamber, the second gas outlet port being arranged in the lower height region of the process chamber and having an elongate shape with a longitudinal direction being substantially parallel to the longitudinal direction of the nozzle element, and wherein the first and second gas outlet ports are arranged at opposite sides of the process chamber with the build area located between them.

16. A nozzle element configured to be used in an additive manufacturing apparatus, according to claim 1, wherein the nozzle element comprises:
an inlet, an outlet, and a plurality of gas flow passages being in fluidic communication with the inlet and the outlet for receiving a gas at the inlet and supplying the gas through the outlet into a process chamber of the additive manufacturing apparatus, and
attachment means for connecting the nozzle element to a ceiling of the process chamber, the attachment means preferably being provided at or near the inlet of the nozzle element,
wherein the outlet of the nozzle element has a substantially elongate shape, the elongate shape defining a longitudinal direction of the nozzle element, and wherein the plurality of gas flow passages subdivide a cavity of the nozzle element at least along the longitudinal direction.

17. The use of a nozzle element in an additive manufacturing apparatus, according to claim 1, for producing a three-dimensional object by means of successively solidifying layers of a building material within a build area of the additive manufacturing apparatus, the layers corresponding to cross-sections of the object to be produced,
wherein the additive manufacturing apparatus comprises a process chamber for building the object, the process chamber comprising the build area and a ceiling of the process chamber located opposite the build area,
the nozzle element being arranged in the ceiling of the process chamber and introducing a gas into the process chamber,
wherein the nozzle element comprises an inlet, an outlet, and a plurality of gas flow passages being in fluidic communication with the inlet and the outlet for receiving a gas at the inlet and supplying the gas through the outlet into the process chamber, wherein the outlet faces the build area,
wherein the outlet of the nozzle element has a substantially elongate shape, the elongate shape defining a longitudinal direction of the nozzle element, and wherein the plurality of gas flow passages subdivide a cavity of the nozzle element at least along the longitudinal direction.

18. A method for producing a three-dimensional object in an additive manufacturing apparatus, the method comprising successively solidifying layers of a building material within a build area of the additive manufacturing apparatus, the layers corresponding to cross-sections of the object to be produced,
wherein the additive manufacturing apparatus comprises a process chamber for building the object, the process chamber comprising the build area and a ceiling of the process chamber located opposite the build area, and
a nozzle element for introducing a gas into the process chamber, the nozzle element being arranged in the ceiling of the process chamber,
wherein the nozzle element comprises an inlet, an outlet, and a plurality of gas flow passages being in fluidic communication with the inlet and the outlet for receiving a gas at the inlet and supplying the gas through the outlet into the process chamber, wherein the outlet faces the build area,
wherein the outlet of the nozzle element has a substantially elongate shape, the elongate shape defining a longitudinal direction of the nozzle element, and wherein the plurality of gas flow passages subdivide a cavity of the nozzle element at least along the longitudinal direction, and
wherein the method further comprises introducing a gas through the nozzle element into the process chamber at least temporarily during the manufacturing of the three-dimensional object.

19. A method of generating a gas flow within an additive manufacturing apparatus for producing a three-dimensional object by means of successively solidifying layers of a building material within a build area of the additive manufacturing apparatus, the layers corresponding to cross-sections of the object to be produced,
wherein the additive manufacturing apparatus comprises a process chamber for building the object, the process chamber comprising the build area and a ceiling of the process chamber located opposite the build area,
a gas supply device for generating a gas stream within the process chamber, and
a nozzle element for introducing a gas into the process chamber, the nozzle element being arranged in the ceiling of the process chamber,
wherein the nozzle element comprises an inlet, an outlet, and a plurality of gas flow passages being in fluidic communication with the inlet and the outlet for receiving a gas at the inlet and supplying the gas through the outlet into the process chamber, wherein the outlet faces the build area,
wherein the outlet of the nozzle element has a substantially elongate shape, the elongate shape defining a longitudinal direction of the nozzle element, and wherein the plurality of gas flow passages subdivide a cavity of the nozzle element at least along the longitudinal direction, and
wherein the method comprises introducing gas through the nozzle element into the process chamber at least temporarily during and/or before and/or after the manufacturing of the three-dimensional object.

20. The method of claim 19, wherein the gas stream is formed of partial gas streams, each partial gas stream being supplied from one of the gas flow passages of the nozzle element into the process chamber, wherein a variation of the velocities of the partial gas streams measured and/or acquired at the outlet of the nozzle element is less than 30%.
